(19) United States
(12) Patent Application Publication
(10) Pub. No.: US 2007/0202923 A1
(43) Pub. Date: Aug. 30, 2007

(54) System and method for transferring media content between a portable device and a video display

(75) Inventors: Edward K. Y. Jung, Bellevue, WA (US); Royce A. Levien, Lexington, MA (US); Robert W. Lord, Seattle, WA (US); Mark A. Malamud, Seattle, WA (US); John D. Rinaldo JR., Bellevue, WA (US)

Correspondence Address: ANDERSON LAW GROUP, PLLC, 9600 GREAT HILLS TRAIL, 150W, AUSTIN, TX, 78759, US

(73) Assignee: Searete, LLC, Bellevue, WA (US)

(21) Appl. No.: 11/362,440

(22) Filed: Feb. 24, 2006

(51) Int. Cl. H04H 7/00; H04B 1/38

(52) U.S. Cl. 455/566; 455/3.06

(57) ABSTRACT

A system and method for operating a portable device, includes but is not limited to a method including identifying one or more entities capable of displaying media content available to and/or stored on the portable device, storing one or more user-controlled parameters of the media content on the portable device and transmitting the one or more user-controlled parameters of the media content and/or the media content to the one or more entities capable of displaying media content to direct instantiation of the media content at a resolution appropriate for a predetermined visual display.

### TECHNICAL FIELD

The present application relates generally to entertainment systems.

### SUMMARY

In one aspect, a method for operating a portable device includes but is not limited to identifying one or more entities capable of displaying media content available to and/or stored on the portable device; storing one or more user-controlled parameters of the media content on the portable device; and transmitting the one or more user-controlled parameters of the media content and/or the media content to the one or more entities capable of displaying media content to direct instantiation of the media content at a resolution appropriate for a predetermined visual display In addition to the foregoing, other method aspects are described in the claims, drawings, and text, forming a part of the present application.

In another aspect, a method for tracking media content includes but is not limited to identifying a transmission of media content requested by a user to and/or from an audio/visual controller; transmitting one or more user-controlled parameters of the media content and/or the media content to one or more entities capable of displaying media content to enable an entity to direct instantiation of the media content at a resolution appropriate for a predetermined visual display; and transmitting an indication of the transmitting the media content, and/or the one or more user controlled parameters of the media content, and/or a location chosen by the user to the audio/visual controller to a third media content, and/or a location chosen by the user to the audio/visual controller to a third party for purposes of assessing a fee. In addition to the foregoing, other method aspects are described in the claims, drawings, and text, forming a part of the present application.

In another aspect a method for transferring media content includes but is not limited receiving one or more user-controlled parameters of the media content indicative of a transfer between one or more entities to direct instantiation of the media content at a resolution appropriate for a predetermined visual display; and logging the receiving of the user-controlled parameters to enable an assessment of a fee for the transfer between the one or more entities. In addition to the foregoing, other method aspects are described in the claims, drawings, and text, forming a part of the present application.

In another aspect, a computer program product includes but is not limited to a signal bearing medium, bearing at least one of one or more instructions for identifying one or more entities capable of displaying media content available to and/or stored on the portable device; one or more instructions for the storing one or more user-controlled parameters of the media content on the portable device; and one or more instructions for transmitting the one or more user-controlled parameters of the media content and/or the media content to the one or more entities capable of displaying media content to direct instantiation of the media content at a resolution appropriate for a predetermined visual display. In addition to the foregoing, other computer program product aspects are described in the claims, drawings, and text, forming a part of the present application.

In another aspect, a computer program product includes but is not limited to a signal bearing medium, bearing at least one of one or more instructions for identifying a transmission of media content requested by a user to and/or from an audio/visual controller; one or more instruction for transmitting one or more user-controlled parameters of the media content and/or the media content to one or more entities capable of displaying media content to enable an entity to direct instantiation of the media content at a resolution appropriate for a predetermined visual display; and one or more instructions for transmitting an indication of the transmitting the media content, and/or the one or more user controlled parameters of the media content, and/or a location chosen by the user to the audio/visual controller to a third party for purposes of assessing a fee. In addition to the foregoing, other computer program product aspects are described in the claims, drawings, and text, forming a part of the present application.

In another aspect, a computer program product includes but is not limited to a signal bearing medium, bearing at least one of one or more instructions for receiving one or more user-controlled parameters of the media content indicative of a transfer between one or more entities to direct instantiation of the media content at a resolution appropriate for a predetermined visual display; and one or more instructions for logging the receiving of the user-controlled parameters to enable an assessment of a fee for the transfer between the one or more entities. In addition to the foregoing, other computer program product aspects are described in the claims, drawings, and text, forming a part of the present application.

In one or more various aspects, related systems include but are not limited to circuitry and/or programming for effecting the herein-referenced method aspects; the circuitry and/or programming can be virtually any combination of hardware, software, and/or firmware configured to affect the herein-referenced method aspects depending upon the design choices of the system designer. In addition to the foregoing, other system aspects are described in the claims, drawings, and text forming a part of the present application.

In one aspect, a portable device includes but is not limited to one or more processors, an audio and/or video input and/or output circuitry coupled to the one or more processors, a memory coupled to the one or more processors, a transceiver coupled to the one or more processors, the transceiver configured for transmitting the one or more user-controlled parameters of the media content and/or the media content to the one or more entities capable of displaying media content to direct instantiation of the media content at a resolution appropriate for a predetermined visual display, an access module coupled to the one or more processors, the access module configured for identifying one or more entities capable of displaying media content available to and/or stored on the portable device, and a data store coupled to the one or more processors, the data store configured for storing one or more user-controlled parameters of the media content on the portable device. In addition to the foregoing, other portable device aspects are described in the claims, drawings, and text, forming a part of the present application.

In addition to the foregoing, various other method, system, computer program product, and/or portable device aspects are set forth and described in the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject described herein will become apparent in the text set forth herein.

### BRIEF DESCRIPTION OF THE DRAWINGS

A better understanding of the subject matter of the application can be obtained when the following detailed description of the disclosed embodiments is considered in conjunction with the following drawings, in which:

FIG. 1 is a block diagram of an exemplary computer architecture that supports the claimed subject matter of the present application;

FIG. 2 is a block diagram of a network environment that supports the claimed subject matter of the present application;

FIG. 3 is a block diagram of a portable device appropriate for embodiments of the subject matter of the present application;

FIGS. 4A and 4B illustrate a flow diagram of a method in accordance with an embodiment of the subject matter of the present application.

FIG. 5 illustrates a flow diagram of a method in accordance with an embodiment of the subject matter of the present application; and

FIG. 6 illustrates a flow diagram of a method in accordance with an embodiment of the subject matter of the present application.

### DETAILED DESCRIPTION OF THE DRAWINGS

In the description that follows, the subject matter of the application will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the subject matter of the application is being described in the foregoing context, it is not meant to be limiting as those skilled in the art will appreciate that some of the acts and operations described hereinafter can also be implemented in hardware, software, and/or firmware and/or some combination thereof.

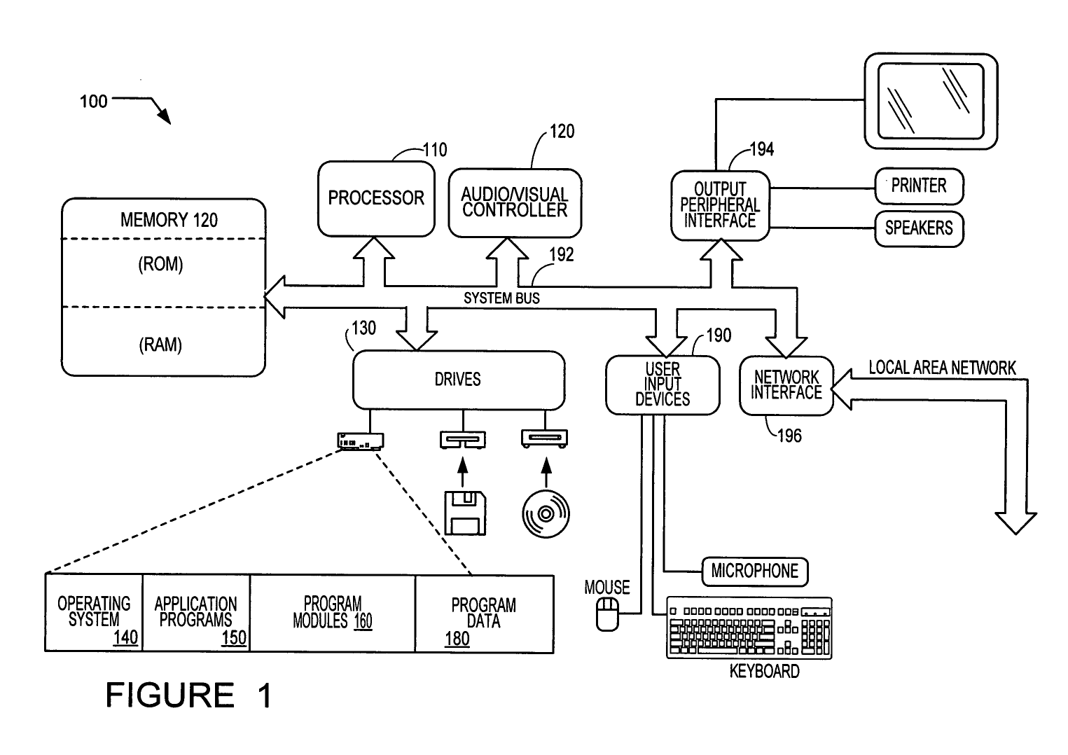

With reference to FIG. 1, depicted is an exemplary computing system for implementing embodiments. FIG. 1 includes a computer 100, which could be a portable computer, including a processor 110, memory 120 and one or more drives 130. The drives 130 and their associated computer storage media, provide storage of computer readable instructions, data structures, program modules and other data for the computer 100. Drives 130 can include an operating system 140, application programs 150, program modules 160, and program data 180. Computer 100 further includes user input devices 190 through which a user may enter commands and data. Input devices can include an electronic digitizer, a microphone, a keyboard and a pointing device, commonly referred to as a mouse, trackball or touch pad. Other input devices may include a joystick, game pad, satellite dish, scanner, and the like. In one or more embodiments, user input devices 190 are portable devices that can direct display or instantiation of applications running on processor 110.

These and other input devices can be connected to processor 110 through a user input interface that is coupled to a system bus 192, but may be connected by other interface and bus structures, such as a parallel port, game port or a universal serial bus (USB). Computers such as computer 100 may also include other peripheral output devices such as speakers and/or display devices, which may be connected through an output peripheral interface 194 and the like.

Computer 100 may operate in a networked environment using logical connections to one or more computers, such as a remote computer. The remote computer may be a personal computer, a server, a router, a network PC, a peer device or other common network node, and may include many if not all of the elements described above relative to computer 100. Networking environments are commonplace in offices, enterprise-wide computer networks, intranets and the Internet. For example, in the subject matter of the present application, computer 100 may comprise the source machine from which data is being migrated, and the remote computer may comprise the destination machine. Note, however, that source and destination machines need not be connected by a network or any other means, but instead, data may be migrated via any media capable of being written by the source platform and read by the destination platform or platforms. When used in a LAN or WLAN networking environment, computer 100 is connected to the LAN through a network interface 196 or an adapter. When used in a WAN networking environment, computer 100 typically includes a modem or other means for establishing communications over the WAN to environments such as the Internet. It will be appreciated that other means of establishing a communications link between the computers may be used.

According to one embodiment, computer 100 is connected in a networking environment such that processor 110 can process incoming data, such as multimedia data, multimedia streams, multimedia content such as audio and/or video content and the like. The incoming data can be to and/or from a portable device or from another data source.

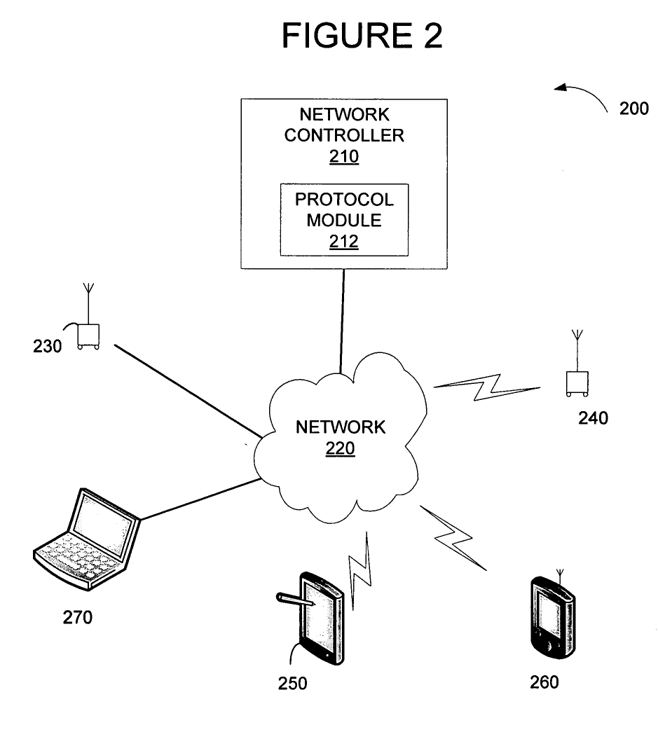

Referring now to FIG. 2, illustrated is an exemplary block diagram of a system 200, including portable devices such as portable computer systems capable of interacting with one or more other computer systems. System 200 is shown including network controller 210, a network 220, and one or more portable devices 230, 240, and 250. Portable devices 230, 240, 250, 260 and 270 may include telephones, wireless telephones, cellular telephones, tablet computers (250), personal digital assistants (260), computer terminals (270) and/or any other devices that are capable of sending and receiving data. Network controller 210 can optionally be disposed within a portable device such as device 230 or the like. For example, the portable device could be disposed within a portable computer system capable of running a network controller 210.

Network controller 210 is connected to network 220. Network controller 210 may be located at a base station, a service center, or any other location on network 220. Network 220 may include any type of network that is capable of sending and receiving communication signals, including signals for multimedia content, data and streaming video.

Network 220 may include a data network, such as the Internet, an intranet, a local area network (LAN), a wide area network (WAN), a cable network, and other like systems that are capable of transmitting multimedia video, streaming video, audio and the like. Network 220 may also include a telecommunications network, such as a local telephone network, long distance telephone network, cellular telephone network, satellite communications network, cable television network and other like communications systems that interact with computer systems to enable set-top boxes or other audio/visual controllers to communicate media and multimedia signals. Network 220 may include more than one network and may include a plurality of different types of networks. Thus, network 220 may include a plurality of data networks, a plurality of telecommunications networks, cable systems, satellite systems and/or a combination of data and telecommunications networks and other like communication systems.

In operation, one of the portable devices 230, 240, 250, 260 or 270, may attempt a communication with a receiving computer system, set-top box, audio/visual controller or network controller. The communication can be routed through network 220 and network controller 210 to the receiving computer system. In an embodiment, network controller 210 is a multimedia content controller capable of determining the type of media content for receiving and/or sending to a portable device. According to an embodiment, network controller 210 can include a protocol module 212 that can determine whether the recipient communication device 240 is requesting streaming video, streaming audio, multimedia content, audio, video, text data or the like. Thus, for example, if network 220 includes several types of data and/or content deliverable to a portable device, the protocol module can be configured to pass only the content and/or data appropriate for the portable device and/or the receiving device. A portable device requesting or sending content can identify itself as capable of receiving data according to a predetermined protocol, including speed of transmission, type of data readable by the portable device, and the like.

Embodiments described herein describe transmitting media content to and/or from a portable device to another device for display. More specifically, embodiments herein describe how a portable device such as portable devices 230, 240, 250, 260 and/or 270 displaying video content can transfer video content to another display with resolution capabilities unavailable and/or unknown to the portable device. Thus, for example, a user of mobile phone displaying video content can transfer the video content to an alternate display, such as a fixed display like a television or the like and the resolution of the video displayed on the alternate display will adjust for the resolution capabilities of the alternate display. In one embodiment, the video display on the portable device can be transferred to another portable device, such as a video display on a mobile phone being transferred to a tablet PC, with the video resolution displayed automatically increasing from a small screen type resolution to a resolution appropriate for proper viewing on the tablet PC.

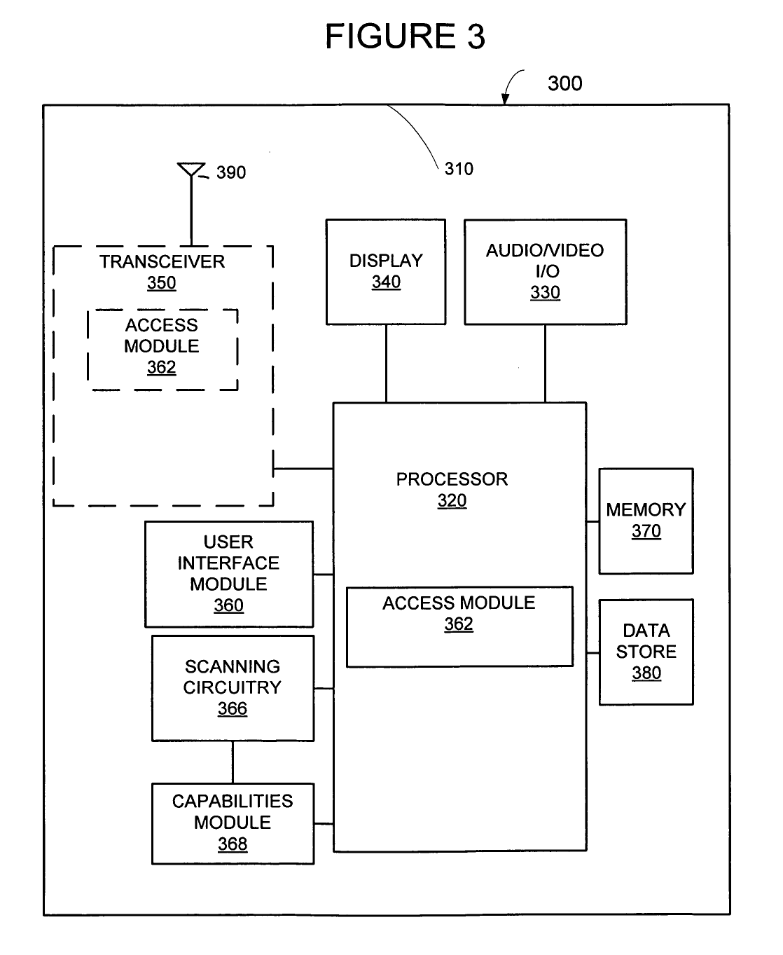

FIG. 3 is an exemplary block diagram of a portable device 300, such as portable devices 230, 240, 250, 260 or 270 according to an embodiment, (e.g. FIG. 2). Portable device 300 can include a housing 310, one or more processors such as processor 320, audio and/or video input and output circuitry 330 coupled to processor 320, a display 340 coupled to processor 320, a user interface 360 coupled to processor 320, a memory 370 coupled to processor 320, and a data store 380 coupled to processor 320. Audio/video input and/or output circuitry 330 can include one or more of a video display, a microphone, a speaker, a transducer, and/or audio input and/or audio output circuitry.

According to an embodiment, processor 320 includes or is coupled to a user interface module 360. User interface module 360 may be installed within processor 320 or may be installed on hardware coupled to the processor 320. Alternatively, user interface 360 could be located in software in memory 370 and executed by processor 320. Memory 370 can include a random access memory, a read only memory, an optical memory, a subscriber identity module memory, or any other memory that can be coupled to a portable device. Display 340 can be a liquid crystal display (LCD), a light emitting diode (LED) display, a plasma display, or any other means for displaying information and have a predetermined resolution capability. Audio/video input and output circuitry 330 can include a microphone, a speaker, a transducer, or any other audio input and output circuitry. User interface 360 can include a keypad, buttons, a touch pad, a joystick, an additional display, or any other device useful for providing an interface between a user and a portable device or display coupled to a portable device.

Processor 320 can be configured to control the functions of portable device 300. Portable device 300 can send and receive signals across network 220 using a transceiver 350 coupled to antenna 390. Alternatively, portable device 300 can be a device relying on twisted pair technology.

Transceiver 350 is shown coupled to processor 320 and can be configured to identify other transceivers. In one embodiment, either or both of processors 320 and/or transceiver 350 can be configured with an access module 362 for accessing the one or more entities computationally capable of being networked to the portable device and identifying one or more entities capable of displaying media content available to and/or stored on the portable device. The access module 362 can include a radio frequency identifier (RFID) type module that receives data identifying the source of content via an RFID protocol, a globally unique identifier (GUID), a protocol following a digital rights management protocol or the like as one with skill in the art with the benefit of the present disclosure will appreciate is appropriate for multimedia content.

According to an embodiment, a user can use either the user interface 360 for input and output of information to and from portable device 300 or use input and output using the audio/video input and output circuitry 330. Data received by portable device 300 can be visually displayed on display 340 and/or provided audibly through audio/video input and output circuitry 330. For example, multimedia applications can be stored on memory 370 and processed by processor 320 to be output via either or both of a visual and/or audio output.

According to one embodiment, the processor 320 and/or transceiver 350 can determine which entities are computationally capable of being networked via scanning circuitry 366 configured for connecting to one or more entities computationally capable of being networked to the portable device. For example, processor 320 in combination with scanning circuitry 366 can be configured to receive wireless or other forms of network electronic transmissions from entities computationally capable of networking with the portable device. Such entities can include other portable devices, signal-generating entities, such as broadcast entities, satellite entities and the like.

Scanning circuitry 366 can further be coupled to capabilities module 368 wherein the capabilities module is configured for determining which of the one or more entities computationally capable of being networked to the portable device is capable of receiving the media content available to and/or stored on the portable device and/or the one or more user-controlled parameters of the media content.

Other computationally capable entities being networked to the portable device can further include communications entities such as cellular service companies, cable service companies, digital subscriber line companies, movies-on-demand companies and the like that have network capabilities. For example, a cable service company following a DOCSIS protocol could enable a portable device to connect to services following a DOCSIS protocol to provide video services which could include streaming video, pay-per-view movies, audio services, radio services and the like.

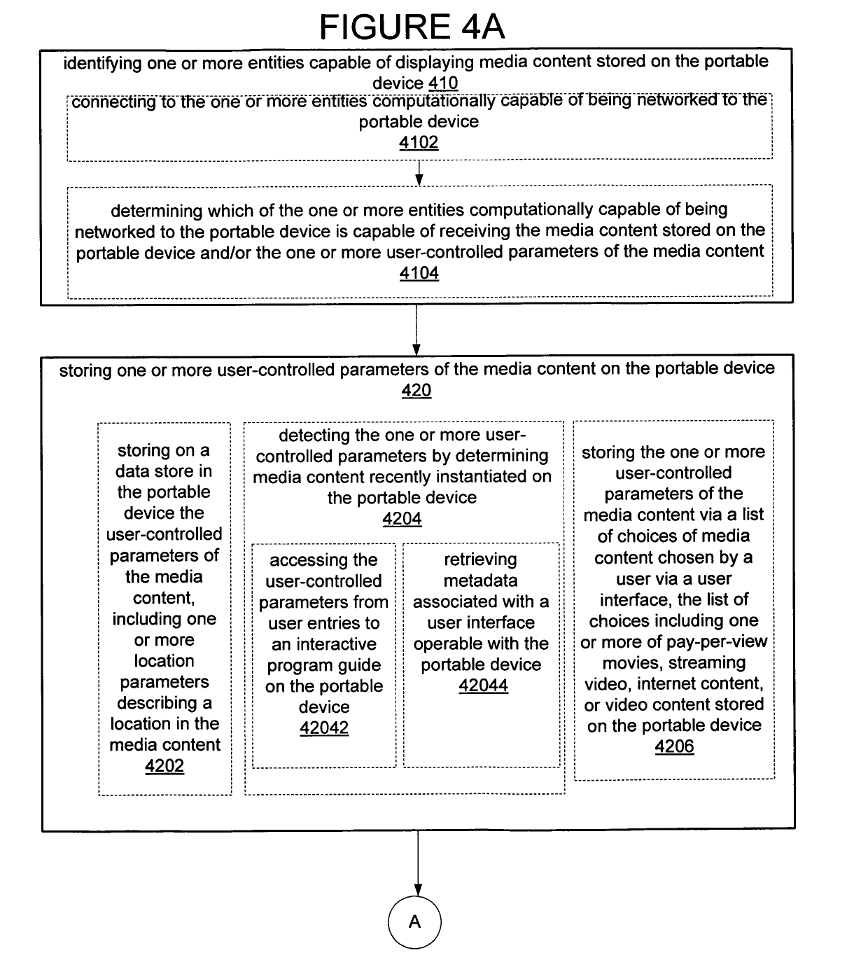

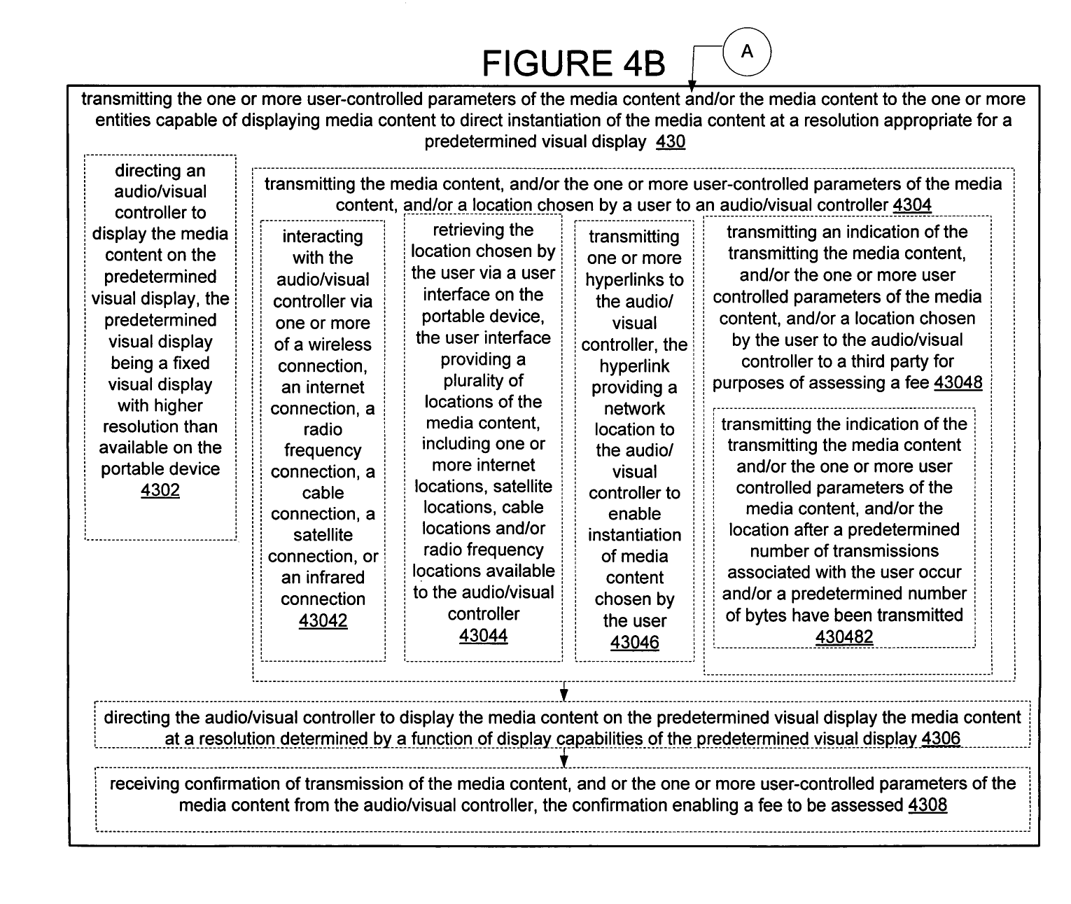

Referring now to FIGS. 4A and 4B, an exemplary flow diagram illustrates the operation of the processor 320 and/or network controller 210 according to an embodiment. One of skill in the art with the benefit of the present disclosure will appreciate that act(s) can be taken by network controller 210 and/or processor 110.

FIGS. 4A and 4B provide methods for operating a portable device to transfer entertainment data to and from the portable device and a second device. The second device can be a fixed device, another portable device or the like.

Block 410 provides for identifying one or more entities capable of displaying media content available to and/or stored on the portable device. For example, processor 320 and/or access module 362 can be configured to identify one or more transceivers capable of being networked to portable device 300 or a computing device such as computer 100 to receive media content from portable device 300. Access module 362 can include code for directing a modem, a wireless detector, a network connection or the like to identify a transceiver appropriate for receiving media content. Depicted within block 410, block 4102 provides for connecting to one or more entities computationally capable of being networked to the portable device. For example, as shown in FIG. 3, transceiver 350 can be configured to operate with processor 320 and access module 362 and scanning circuitry 366 to scan an area or other network connections to access the one or more entities computationally capable of being networked to the portable device or computing device. Block 4102 is connected to block 4104 which provides for determining which of the one or more entities computationally capable of being networked to the portable device is capable of receiving the media content available to and/or stored on the portable device and/or the one or more user-controlled parameters of the media content. For example, after connecting to one or more entities as provided for in block 4102, block 4104 can provide that processor 320 and/or access module 362 determine an appropriate entity for networking to the portable device. In one embodiment, scanning circuitry 366 in combination with capabilities module 368 perform checking to determine which entities are computationally capable of being networked. Thus, for example, an entity that connects to a network with a slow connection can be excluded from consideration as a possible video streaming candidate.

Depicted within block 4104 is block 41042 which provides for receiving an indication from an entity controlling the predetermined visual display that the media content described by the one or more user-controlled parameters will be transferred from the predetermined visual display to the portable device for display. For example, processor 320 and/or access module 362 can receive an indication that user-controlled parameters of the media content refer to media content being displayed on a predetermined visual display. A predetermined visual display can include a fixed display, such as a television. Thus, a portable device can receive user-controlled parameters indicative that media content on a television will be transferred to the portable device. The media content can be transferred via a network controller 210, which can be a television controller, or other type of controller capable of directing the transfer of media content from an entity directing the predetermined visual display or from another source of media content.

Block 420 provides for storing one or more user-controlled parameters of the media content on the portable device. For example, data store 380 or memory 370 in combination with processor 320 can be configured to store user-controlled parameters of media content on the portable device. Depicted within block 420 is block 4202 which provides for storing on a data store in the portable device the user-controlled parameters of the media content, including one or more location parameters describing a location in the media content. For example, in one embodiment, the user-controlled parameters of the media content include parameters identifying a location in media content such as a location in a movie being watched by a user or the like. If a user is watching a movie on a portable device 300 and wishes to transfer the media to another visual display, the user-controlled parameters can include a time remaining on the media content so that the user does not have to watch more or less content than desirable. Further, in one embodiment, the transferred content can be edited to prevent transfer of content already viewed by a user.

Also depicted within block 420 is block 4204 which provides for detecting the one or more user-controlled parameters by determining media content recently instantiated on the portable device. For example, referring to FIG. 3, processor 320 in combination with user interface 360 can determine which media content was recently played on the portable device and use the metadata or other indications of the media recently instantiated as the user-controlled parameters governing the data sent over a network for display on an alternate video display.

Depicted within block 4204 is block 42042 which provides for accessing the user-controlled parameters from user entries to an interactive program guide on the portable device. For example, processor 320 can be configured to retrieve interactive program guide data and/or content from user interface 360 by tracking choices made by the user regarding interactive program guide data. Also depicted within block 4204 is block 42044 which provides for retrieving metadata associated with a user interface operable with the portable device. For example, processor 320 in combination with data store 380 can be configured to retrieve and store metadata associated with user interface 360 to detect user-controlled parameters and/or locations chosen by a user indicative of media content played on the portable device or for transmission to an alternative video display.

Block 4204 is followed by block 4206 which provides for storing the one or more user-controlled parameters of the media content via a list of choices of media content chosen by a user via a user interface, the list of choices including one or more of pay-per-view movies, streaming video, internet content, or video content stored on the portable device. For example, processor 320 in combination with data store 380 and user interface 360 can detect and store a list of choices of media content. If a list of choices includes different size videos, a transmission can be configured to transmit smaller video content first and/or avoid larger video content as a function of the bandwidth of a network required to transmit the content to the alternate video display.

Referring now to FIG. 4B, block 430 provides for transmitting the one or more user-controlled parameters of the media content and/or the media content to the one or more entities capable of displaying media content to direct instantiation of the media content at a resolution appropriate for a predetermined visual display. For example, processor 320 in combination with transceiver 350 can direct transmission of the media content and/or the user-controlled parameters of the media content to enable an entity to display content previously shown on the portable device to be shown on the predetermined visual display. If the predetermined visual display has a higher resolution capability than the portable device, according to an embodiment, the media content is shown at the higher resolution.

Depicted within block 430 is block 4302 which provides for directing an audio/visual controller to display the media content on the predetermined visual display, the predetermined visual display being a fixed visual display with higher resolution than available on the portable device. For example, processor 320 in combination with transceiver 350 can provide signals to an audio/visual controller via a network to direct display of the media content. In an embodiment, the fixed visual display is a higher resolution display as compared to the display of the portable device. The media content transferred to the fixed visual display can be adjustable to different displays such that instantiating the media content on the portable device does not alter the media content so as to prevent alternate resolution display from being prohibited.

Also depicted within block 430 is block 4304 which provides for transmitting the media content, and/or the one or more user-controlled parameters of the media content, and/or a location chosen by a user to an audio/visual controller. For example, processor 320 in combination with transceiver 350 and data store 380 can be configured to transmit the media content, user-controlled parameters and/or a location chosen by a user to an audio/visual controller. The audio/visual controller can be a network controller as illustrated in FIG. 2 or can be an in-home device such as a television controller, internet controller or the like.

Depicted within block 4304 is block 43042 which provides for interacting with the audio/visual controller via one or more of a wireless connection, an internet connection, a radio frequency connection, a cable connection, a satellite connection, or an infrared connection. For example, a portable device that is a mobile phone can interact with the audio/visual controller via a plurality of different types of connections that enable transfer of media content, user-controlled parameters, a location chosen by a user and the like.

Also depicted within block 4304 is block 43044 which provides for retrieving the location chosen by the user via a user interface on the portable device, the user interface providing a plurality of locations of the media content, including one or more internet locations, satellite locations, cable locations and/or radio frequency locations available to the audio/visual controller. For example, processor 320 and user interface 360 can operate to retrieve locations, such as locations in a movie, URL locations, and the like.

Block 43046 is also depicted within block 4304 and provides for transmitting one or more hyperlinks to the audio/visual controller, the hyperlink providing a network location to the audio/visual controller to enable instantiation of media content chosen by the user. For example, processor 320 and transceiver 350 can operate to transmit a URL and/or hyperlink to a network to enable a display to show the content requested by a user.

Block 43048 is also depicted within block 4304 and provides for transmitting an indication of the transmitting the media content, and/or the one or more user controlled parameters of the media content, and/or a location chosen by the user to the audio/visual controller to a third party for purposes of assessing a fee. For example, processor 320 in combination with transceiver 350 can receive signals from an audio/visual controller via a network that the media content was transmitted. The indication can be either an indication that the content completed transmission, that the transmission was started or that a transmission was requested. The indication can be sent to a third party, which can be an entity capable of assessing a fee for the transmission.

Within block 43048 is block 430482 which provides for transmitting the indication of the transmitting the media content and/or the one or more user controlled parameters of the media content, and/or the location after a predetermined number of transmissions associated with the user occur and/or a predetermined number of bytes have been transmitted. For example, in one embodiment, a network controller, such as network controller 210 can receive signals from an audio/visual controller via a network such as network 220. The indication can be transmitted from portable device 300 or from another entity such as those shown in FIG. 2, indicative of the media content being transmitted and/or user-controlled parameters of the media content being transmitted, or a location that identifies media content to be transmitted or the like. The network controller can be a controller that maintains statistics on the number of bytes transferred and/or the number of transmissions that occur on a network. The statistics can be used for purposes of assessing a fee for users that transfer the media content.

Block 4304 is followed by block 4306 which provides for directing the audio/visual controller to display the media content on the predetermined visual display the media content at a resolution determined by a function of display capabilities of the predetermined visual display. For example, processor 320 in combination with transceiver 350 can provide signals to an audio/visual controller via a network to direct display of the media content. In an embodiment, the predetermined visual display can be either a higher resolution or a lower resolution than the portable device and is determined by a function of the display capabilities of the destination visual display. Thus, for example, if the destination visual display has lower resolution than can be appreciated by the resolution capabilities of the content, in an embodiment, the transceiver takes that into account. The transceiver, rather than transmitting more bits than necessary for the receiving entity can transmit the maximum number required for the highest resolution of the destination visual display. Conversely, if the portable device holds or has access to content that can be displayed at a higher resolution than is feasible for the portable device, but is transferable to a higher quality display, the transceiver, in an embodiment, transfers more bits than would otherwise be transferred. In another embodiment, the transceiver uses a function that includes the transmission rate available to the portable device, the resolution capabilities of the predetermined visual display, and the resolution possibilities of the content within or available to the portable device to determine how content should be transferred to an entity.

Block 4306 is followed by block 4308 which provides for receiving confirmation of transmission of the media content, and or the one or more user-controlled parameters of the media content from the audio/visual controller, the confirmation enabling a fee to be assessed. For example, processor 320 in combination with transceiver 350 can receive signals from an audio/visual controller via a network that the media content was received as a confirmation of the transmission. Once a confirmation of transmission is received, the portable device can send an indication to a third party vendor, a cell phone company, a broadband company, a satellite company or any other third party that the media content was transferred so that a fee can be assessed. Also, the third party can be the audio/visual controller, which can send data to another entity, such as an entity associated with the audio/visual controller.

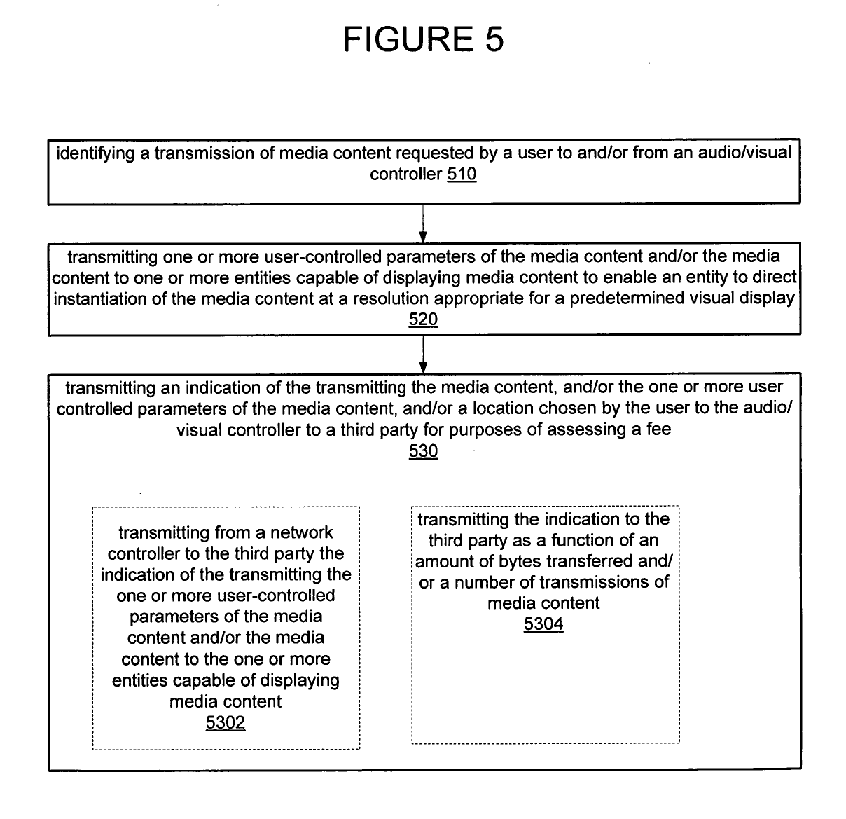

Referring now to FIG. 5, methods for tracking media content are described. More particularly, block 510 provides for identifying a transmission of media content requested by a user to and/or from an audio/visual controller. For example, network controller 210 can identify transmissions occurring in network 220 via audio/visual controller 120 shown in FIG. 1 or another network controller 210. Block 520 provides for transmitting one or more user-controlled parameters of the media content and/or the media content to one or more entities capable of displaying media content to enable an entity to direct instantiation of the media content at a resolution appropriate for a predetermined visual display. For example, processor 320 in combination with transceiver 350 can provide signals to an audio/visual controller via a network to enable portable device 300 or a fixed entity direct display of the media content. In an embodiment, the visual display is a higher resolution display as compared to the display of the portable device or vice versa. Block 530 provides for transmitting an indication of the transmitting the media content, and/or the one or more user controlled parameters of the media content, and/or a location chosen by the user to the audio/visual controller to a third party for purposes of assessing a fee. For example, in an embodiment, network controller 210, or transceiver 350 in combination with processor 320, or audio/visual control 120 can transmit an indication of the transmitting the media content to a third party. The third party could include mobile phone companies, telecommunications companies, third party companies and the like.

Disposed within block 530 is block 5302 and 5304. Block 5302 provides for transmitting from a network controller to the third party the indication of the transmitting the one or more user-controlled parameters of the media content and/or the media content to the one or more entities capable of displaying media content. For example, in an embodiment, a network controller 210 transmits the indication of the transmission of media content or user-controlled parameters. The network controller can be a controller tracking transmission within a large or small network, including an in-home network such that the transmitting to a third party includes transmitting from a set-top box or other audio/visual controller to a service provider. Block 5304 provides for transmitting the indication to the third party as a function of an amount of bytes transferred and/or a number of transmissions of media content. Thus, for example, network controller 210 and/or transceiver 350 in combination with processor 320 can transmit the indication when appropriate under the terms of a service agreement or the like. The transmission can be gauged to transmit after a predetermined number of bytes or a number of transmissions of media content.

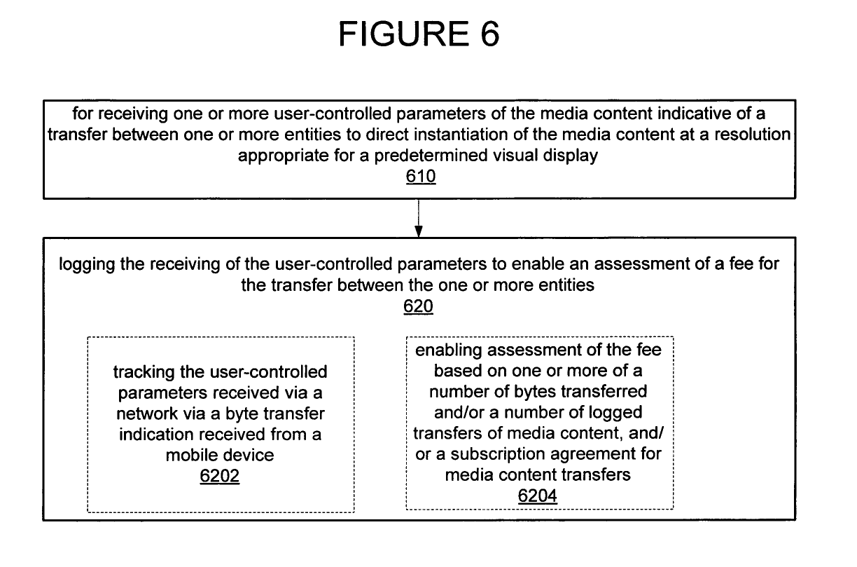

FIG. 6 provides a flow diagram illustrating a method for transferring media content. More particularly, block 610 provides for receiving one or more user-controlled parameters of the media content indicative of a transfer between one or more entities to direct instantiation of the media content at a resolution appropriate for a predetermined visual display. For example, network 220 and/or network controller 210 can receive user-controlled parameters that indicate that a transfer occurred to and/or from devices 230, 240, 250, 260, and/or 270.

Block 620 provides for logging the receiving of the user-controlled parameters to enable an assessment of a fee for the transfer between the one or more entities. For example, network controller 21 0 can log that the user-controlled parameters were received to enable a third party or another entity to assess a fee for the transfer. Disposed within block 620 is block 6202 which provides for tracking the user-controlled parameters received via a network via a byte transfer indication received from a mobile device. For example, logging the receipt of user-controlled parameters by network controller 210 can include tracking via network 220 how many bytes were transferred from any one of devices 230, 240, 250, 260, and/or 270, any one of which can be mobile devices.

Also depicted in block 620 is block 6204, which provides for enabling assessment of the fee based on one or more of a number of bytes transferred and/or a number of logged transfers of media content, and/or a subscription agreement for media content transfers. For example, the assessing the fee can be done by the network controller 210 based on the logging performed by the network controller. In another embodiment, the network controller can track the number of bytes and/or number of transmissions of media content to enable the fee to be assessed in accordance with statistics that are logged by the network controller. In one embodiment, a third party determines the fee according to the statistics provided by the network controller and/or a mobile device 300 or the like. Alternatively, a third party can determine a fee according to a subscription agreement that is known to a user.

Those with skill in the computing arts will recognize that the disclosed embodiments have relevance to a wide variety of applications and architectures in addition to those described above. In addition, the functionality of the subject matter of the present application can be implemented in software, hardware, or a combination of software and hardware. The hardware portion can be implemented using specialized logic; the software portion can be stored in a memory or recording medium and executed by a suitable instruction execution system such as a microprocessor.

While the subject matter of the application has been shown and described with reference to particular embodiments thereof, it will be understood by those skilled in the art that the foregoing and other changes in form and detail may be made therein without departing from the spirit and scope of the subject matter of the application, including but not limited to additional, less or modified elements and/or additional, less or modified blocks performed in the same or a different order.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.)

The herein described subject matter sometimes illustrates different components contained within, or connected with, different other components. It is to be understood is that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Those skilled in the art will recognize that it is common within the art to implement devices and/or processes and/or systems in the fashion(s) set forth herein, and thereafter use engineering and/or business practices to integrate such implemented devices and/or processes and/or systems into more comprehensive devices and/or processes and/or systems. That is, at least a portion of the devices and/or processes and/or systems described herein can be integrated into comprehensive devices and/or processes and/or systems via a reasonable amount of experimentation. Those having skill in the art will recognize that examples of such comprehensive devices and/or processes and/or systems might include—as appropriate to context and application—all or part of devices and/or processes and/or systems of (a) an air conveyance (e.g., an airplane, rocket, hovercraft, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Quest, Southwestern Bell, etc.); or (g) a wired/wireless services entity such as Sprint, Cingular, Nextel, etc.), etc.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

We claim:

1. A method for operating a portable device, the method comprising:
identifying one or more entities capable of displaying media content available to and/or stored on the portable device;
storing one or more user-controlled parameters of the media content on the portable device; and
transmitting the one or more user-controlled parameters of the media content and/or the media content to the one or more entities capable of displaying media content to direct instantiation of the media content at a resolution appropriate for a predetermined visual display.

2. The method of claim 1 wherein the identifying one or more entities capable of displaying media content available to and/or stored on the portable device includes:
connecting to one or more entities computationally capable of being networked to the portable device; and
determining which of the one or more entities computationally capable of being networked to the portable device is capable of receiving the media content available to and/or stored on the portable device and/or the one or more user-controlled parameters of the media content.

3. The method of claim 2 wherein the determining which of the one or more entities computationally capable of being networked to the portable device is capable of receiving the media content available to and/or stored on the portable device and/or the one or more user-controlled parameters of the media content includes:
receiving an indication from an entity controlling the predetermined visual display that the media content described by the one or more user-controlled parameters will be transferred from the predetermined visual display to the portable device for display.

4. The method of claim 1 wherein the storing one or more user-controlled parameters of the media content on the portable device includes:
storing on a data store in the portable device the user-controlled parameters of the media content, including one or more location parameters describing a location in the media content.

5. The method of claim 1 wherein the storing one or more user-controlled parameters of the media content on the portable device includes:
detecting the one or more user-controlled parameters by determining media content recently instantiated on the portable device.

6. The method of claim 5 wherein the detecting the one or more user-controlled parameters by determining media content recently instantiated on the portable device includes:
accessing the user-controlled parameters from user entries to an interactive program guide on the portable device.

7. (canceled)

8. The method of claim 1 wherein the storing one or more user-controlled parameters of the media content on the portable device includes:
storing the one or more user-controlled parameters of the media content via a list of choices of media content chosen by a user via a user interface, the list of choices including one or more of pay-per-view movies, streaming video, internet content, or video content stored on the portable device.

9. The method of claim 1 wherein the transmitting the one or more user-controlled parameters of the media content and/or the media content to the one or more entities capable of displaying media content to direct instantiation of the media content at a resolution appropriate for a predetermined visual display includes:
directing an audio/visual controller to display the media content on the predetermined visual display, the predetermined visual display being a fixed visual display with higher resolution than available on the portable device.

10. The method of claim 1 wherein the transmitting the one or more user-controlled parameters of the media content and/or the media content to the one or more entities capable of displaying media content to direct instantiation of the media content at a resolution appropriate for a predetermined visual display includes:
transmitting the media content, and/or the one or more user-controlled parameters of the media content, and/or a location chosen by a user to an audio/visual controller;
directing the audio/visual controller to display the media content on the predetermined visual display the media content at a resolution determined by a function of display capabilities of the predetermined visual display; and
receiving confirmation of transmission of the media content, and or the one or more user-controlled parameters of the media content from the audio/visual controller, the confirmation enabling a fee to be assessed

11. (canceled)

12. (canceled)

13. The method of claim 10 wherein the transmitting the media content, and/or the one or more user-controlled parameters of the media content, and/or a location chosen by a user to an audio/visual controller includes:
transmitting one or more hyperlinks to the audio/visual controller, the hyperlink providing a network location to the audio/visual controller to enable instantiation of media content chosen by the user.

14. The method of claim 10 wherein the transmitting the media content, and/or the one or more user-controlled parameters of the media content, and/or a location chosen by a user to an audio/visual controller includes:
transmitting an indication of the transmitting the media content, and/or the one or more user controlled parameters of the media content, and/or a location chosen by the user to the audio/visual controller to a third party for purposes of assessing a fee.

15. The method of claim 14 wherein the transmitting an indication of the transmitting the media content, and/or the one or more user controlled parameters of the media content, and/or a location chosen by the user to the audio/visual controller to a third party for purposes of assessing a fee includes:
transmitting the indication of the transmitting the media content and/or the one or more user controlled parameters of the media content, and/or the location after a predetermined number of transmissions associated with the user occur and/or a predetermined number of bytes have been transmitted.

16. (canceled)

17. (canceled)

18. (canceled)

19. A method for transferring media content, the method comprising:
receiving one or more user-controlled parameters of the media content indicative of a transfer between one or more entities to direct instantiation of the media content at a resolution appropriate for a predetermined visual display; and
logging the receiving of the user-controlled parameters to enable an assessment of a fee for the transfer between the one or more entities.

20. The method of claim 19 wherein the logging the receiving of the user-controlled parameters to enable an assessment of a fee for the transfer between the one or more entities includes:
tracking the user-controlled parameters received via a network via a byte transfer indication received from a mobile device.

21. The method of claim 19 wherein the logging the receiving of the user-controlled parameters to enable an assessment of a fee for the transfer between the one or more entities includes:
enabling assessment of the fee based on one or more of a number of bytes transferred and/or a number of logged transfers of media content, and/or a subscription agreement for media content transfers.

22. A computer program product comprising:
a signal bearing medium bearing;
one or more instructions for identifying one or more entities capable of displaying media content available to and/or stored on the portable device;
one or more instructions for storing one or more user-controlled parameters of the media content on the portable device; and
one or more instructions for transmitting the one or more user-controlled parameters of the media content and/or the media content to the one or more entities capable of displaying media content to direct instantiation of the media content at a resolution appropriate for a predetermined visual display.

23. The computer program product of claim 22 wherein the signal bearing medium comprises:
a recordable medium.

24. The computer program product of claim 22 wherein the signal bearing medium comprises:
a transmission medium.

25. The computer program product of claim 22 wherein the one or more instructions for identifying one or more entities capable of displaying media content available to and/or stored on the portable device includes:
one or more instructions for connecting to one or more entities computationally capable of being networked to the portable device; and
one or more instructions for determining which of the one or more entities computationally capable of being networked to the portable device is capable of receiving the media content available to and/or stored on the portable device and/or the one or more user-controlled parameters of the media content.

26. The computer program product of claim 22 wherein the one or more instructions for determining which of the one or more entities computationally capable of being networked to the portable device is capable of receiving the media content available to and/or stored on the portable device and/or the one or more user-controlled parameters of the media content includes:
one or more instructions for receiving an indication from an entity controlling the predetermined visual display that the media content described by the one or more user-controlled parameters will be transferred from the predetermined visual display to the portable device for display.

27. (canceled)

28. The computer program product of claim 22 wherein the storing one or more user-controlled parameters of the media content on the portable device includes:
one or more instructions for detecting the one or more user-controlled parameters by determining media content recently instantiated on the portable device.

29. (canceled)

30. The computer program product of claim 28 wherein the one or more instructions for the detecting the one or more user-controlled parameters by determining media content recently instantiated on the portable device includes:
one or more instructions for retrieving metadata associated with a user interface operable with the portable device.

31. (canceled)

32. (canceled)

33. The computer program product of claim 22 wherein the one or more instructions for transmitting the one or more user-controlled parameters of the media content and/or the media content to the one or more entities capable of displaying media content to direct instantiation of the media content at a resolution appropriate for a predetermined visual display includes:
one or more instructions for transmitting the media content, and/or the one or more user-controlled parameters of the media content, and/or a location chosen by a user to an audio/visual controller;
one or more instructions for directing the audio/visual controller to display the media content on the predetermined visual display the media content at a resolution determined by a function of display capabilities of the predetermined visual display; and
one or more instructions for receiving confirmation of transmission of the media content, and or the one or more user-controlled parameters of the media content from the audio/visual controller, the confirmation enabling a fee to be assessed

34. (canceled)

35. The computer program product of claim 33 wherein the one or more instructions for transmitting the media content, and/or the one or more user-controlled parameters of the media content, and/or a location chosen by a user to an audio/visual controller includes:
one or more instructions for retrieving the location chosen by the user via a user interface on the portable device, the user interface providing a plurality of locations of the media content, including one or more internet locations, satellite locations, cable locations and/or radio frequency locations available to the audio/visual controller.

36. The computer program product of claim 33 wherein the one or more instructions for transmitting the media content, and/or the one or more user-controlled parameters of the media content, and/or a location chosen by a user to an audio/visual controller includes:
one or more instructions for transmitting one or more hyperlinks to the audio/visual controller, the hyperlink providing a network location to the audio/visual controller to enable instantiation of media content chosen by the user.

37. The computer program product of claim 33 wherein the one or more instructions for transmitting the media content, and/or the one or more user-controlled parameters of the media content, and/or a location chosen by a user to an audio/visual controller includes:
one or more instructions for transmitting an indication of the transmitting the media content, and/or the one or more user controlled parameters of the media content, and/or a location chosen by the user to the audio/visual controller to a third party for purposes of assessing a fee.

38. The computer program product of claim 37 wherein the one or more instructions for transmitting an indication of the transmitting the media content, and/or the one or more user controlled parameters of the media content, and/or a location chosen by the user to the audio/visual controller to a third party for purposes of assessing a fee includes:
one or more instructions for transmitting the indication of the transmitting the media content and/or the one or more user controlled parameters of the media content, and/or the location after a predetermined number of transmissions associated with the user occur and/or a predetermined number of bytes have been transmitted.

39. A computer program product comprising:
a signal bearing medium bearing;
one or more instructions for identifying a transmission of media content requested by a user to and/or from an audio/visual controller;
one or more instructions for transmitting one or more user-controlled parameters of the media content and/or the media content to one or more entities capable of displaying media content to enable an entity to direct instantiation of the media content at a resolution appropriate for a predetermined visual display; and
one or more instructions for transmitting an indication of the transmitting the media content, and/or the one or more user controlled parameters of the media content, and/or a location chosen by the user to the audio/visual controller to a third party for purposes of assessing a fee.

40. The computer program product of claim 39 wherein the one or more instructions for transmitting an indication of the transmitting the media content, and/or the one or more user controlled parameters of the media content, and/or a location chosen by the user to the audio/visual controller to a third party for purposes of assessing a fee includes:
one or more instructions for transmitting from a network controller to the third party the indication of the transmitting the one or more user-controlled parameters of the media content and/or the media content to the one or more entities capable of displaying media content.

41. The computer program product of claim 39 wherein the one or more instructions for transmitting an indication of the transmitting the media content, and/or the one or more user controlled parameters of the media content, and/or a location chosen by the user to the audio/visual controller to a third party for purposes of assessing a fee includes:
one or more instructions for transmitting the indication to the third party as a function of an amount of bytes transferred and/or a number of transmissions of media content.

42. (canceled)

43. (canceled)

44. (canceled)

45. A portable device comprising:
one or more processors;
audio and/or video input and/or output circuitry coupled to the one or more processors;
a memory coupled to the one or more processors;
a transceiver coupled to the one or more processors, the transceiver configured for transmitting the one or more user-controlled parameters of the media content and/or the media content to the one or more entities capable of displaying media content to direct instantiation of the media content at a resolution appropriate for a predetermined visual display;
an access module coupled to the one or more processors, the access module configured for identifying one or more entities capable of displaying media content available to and/or stored on the portable device; and
a data store coupled to the one or more processors, the data store configured for storing one or more user-controlled parameters of the media content on the portable device.

46. (canceled)

47. The portable device of claim 45 wherein the memory is one or more of a random access memory, a read only memory, or an optical memory.

48. (canceled)

49. The portable device of claim 45 wherein the identifying one or more entities capable of displaying media content available to and/or stored on the portable device includes:
means for connecting to one or more entities computationally capable of being networked to the portable device; and
means for determining which of the one or more entities computationally capable of being networked to the portable device is capable of receiving the media content available to and/or stored on the portable device and/or the one or more user-controlled parameters of the media content.

50. (canceled)

51. The portable device of claim 45 further comprising a housing coupled to the processor, the housing encasing the memory, the processor, the transceiver and/or the audio/video input and/or output circuitry.

52. The portable device of claim 51 wherein the housing encasing the memory, the processor, the transceiver and/or the audio/video input and/or output circuitry is a mobile phone, a portable computer, a personal digital assistant, and/or a remote control device.

53. (canceled)

54. The portable device of claim 45 wherein the data store configured for storing one or more user-controlled parameters of the media content on the portable device includes means for detecting the one or more user-controlled parameters by determining media content recently instantiated on the portable device.

55. (canceled)

56. (canceled)

57. The portable device of claim 54 wherein means for detecting the one or more user-controlled parameters by determining media content recently instantiated on the portable device include means for storing the one or more user-controlled parameters of the media content via a list of choices of media content chosen by a user via a user interface, the list of choices including one or more of pay-per-view movies, streaming video, internet content, or video content stored on the portable device.

58. (canceled)

59. (canceled)

60. The portable device of claim 45 wherein the transceiver configured for transmitting the one or more user-controlled parameters of the media content and/or the media content to the one or more entities capable of displaying media content to direct instantiation of the media content at a resolution appropriate for a predetermined visual display includes:
means for transmitting the media content, and/or the one or more user-controlled parameters of the media content, and/or a location chosen by a user to an audio/visual controller; and
means for directing the audio/visual controller to display the media content on the predetermined visual display the media content at a resolution determined by a function of display capabilities of the predetermined visual display

61. (canceled)

62. The portable device of claim 58 wherein the transceiver configured for transmitting the media content, and/or the one or more user-controlled parameters of the media content, and/or a location chosen by a user to an audio/visual controller includes means for retrieving the location chosen by the user via a user interface on the portable device, the user interface providing a plurality of locations of the media content, including one or more internet locations, satellite locations, cable locations and/or radio frequency locations available to the audio/visual controller.

63. The portable device of claim 58 wherein the transceiver configured for transmitting the media content, and/or the one or more user-controlled parameters of the media content, and/or a location chosen by a user to an audio/visual controller includes means for transmitting one or more hyperlinks to the audio/visual controller, the hyperlink providing a network location to the audio/visual controller to enable instantiation of media content chosen by the user.
